(19) United States
(12) Patent Application Publication
(10) Pub. No.: US 2014/0174312 A1
(43) Pub. Date: Jun. 26, 2014

(54) COMPOSITION FOR GRAVURE OFFSET PRINTING AND GRAVURE OFFSET PRINTING PROCESS

(71) Applicant: Industrial Technology Research Institute, Hsinchu (TW)

(72) Inventors: Yu-Ming WANG, Taichung City (TW); Chih-Wei HSIEH, Pitou Township (TW)

(73) Assignee: Industrial Technology Research Institute, Hsinchu (TW)

(21) Appl. No.: 14/075,542

(22) Filed: Nov. 8, 2013

(30) Foreign Application Priority Data
Dec. 26, 2012 (TW) 101150034

(51) Int. Cl. C09D 11/02; C09K 13/06; C09D 11/00

(52) U.S. Cl. CPC C09D 11/02; C09D 11/52; C09K 13/06
USPC 101/492; 252/514; 524/378; 252/79.4

(57) ABSTRACT

The disclosure provides a composition for gravure offset printing, including 7-92 parts by weight of a functional material, 1-76 parts by weight of a polymer, 4-13 parts by weight of a solvent, and 1-2.5 parts by weight of an additive, wherein a surface tension of the composition is between 20-40 mN/m. The disclosure further provides a gravure offset printing process, including providing a template containing a gravure pattern, filling the composition in the gravure pattern of the template, transferring the composition from the template onto a blanket, and transferring the composition from the blanket to a substrate, wherein a transfer ratio of the composition from the blanket to the substrate is above 80%.

### CROSS REFERENCE TO RELATED APPLICATIONS

This application is based upon and claims the benefit of priority from the prior Taiwan Patent Application No. 101150034, filed on Dec. 26, 2012, the entire contents of which are incorporated herein by reference.

### TECHNICAL FIELD

The technical field relates to a coating composition, in particular relates to a composition for gravure offset printing.

### BACKGROUND

Printed electronic products possess a great market potential. There is a continuing goal to miniaturize. To satisfy the design requirement of lighter, smaller, or thinner, the volume of each component utilized in the product is strictly limited. Taking conductive wires as an example, the most common component in printed electronic products, the line width thereof is reduced from hundred micron scale to several micron scale. Screen printing is typically used in the manufacture of traditional conductive wires. However, the mass-producible line width is only down to 70 μm due to the intrinsic limitations of the screen. Obviously, such a process capability is insufficient for the process for currently popular touch panel. To achieve fine wire production, most manufacturers rely on photolithography technology. Although this process can produce wires with a line width less than 10 micron, the production cost is significantly higher than that of the printing process. Moreover, this process is not environmentally friendly because of the huge consumption of energy and materials.

To provide cost effective production for fine wires, gravure offset printing has been widely investigated and under trial-production in the industry in recent years. However, the transfer ratio of the current known gravure offset printing composition is still low.

Therefore, improvements on the composition for gravure offset printing and the process thereof are desirable.

### SUMMARY

In one aspect, the disclosure provides a composition for gravure offset printing, including 7-92 parts by weight of a functional material, 1-76 parts by weight of a polymer , 4-13 parts by weight of a solvent, and 1-2.5 parts by weight of an additive, wherein a surface tension of the composition is between 20-40 mN/m.

In another aspect, the disclosure also provides a gravure offset printing process, including providing a template containing a gravure pattern; filling the composition in the gravure pattern of the template, wherein the composition includes 7-92 parts by weight of a functional material, 1-76 parts by weight of a polymer , 4-13 parts by weight of a solvent, and 1-2.5 parts by weight of an additive, and a surface tension of the composition is between 20-40 mN/m; transferring the composition from the template onto a blanket; and transferring the composition from the blanket to a substrate, wherein a transfer ratio of the composition from the blanket to the substrate is above 80%.

A detailed description is given in the following embodiments with reference to the accompanying drawings.

### BRIEF DESCRIPTION OF DRAWINGS

The disclosure can be more fully understood by reading the subsequent detailed description and examples with references made to the accompanying drawings, wherein:

FIG. 1 is a flowchart of the gravure offset printing process according to embodiments of the disclosure;

FIG. 2A-2E show schematic views of various stages of the gravure offset printing process according to embodiments of the disclosure;

FIG. 3A-3B show the results of gravure offset printing test of etching compositions according to embodiments of the disclosure;

FIG. 4A-4B show the results of gravure offset printing test of insulating compositions according to embodiments of the disclosure; and

FIG. 5 shows the range of surface tension of the composition for gravure offset printing according to embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure relates to a composition for gravure offset printing, in which different functional materials may be added to provide the composition with conductivity, isolating properties, high refractive index or ability to etch a substrate. Moreover, the composition may be used to print a line width of less than 50 μm to conform with the requirement of fine wires.

According to one embodiment, the disclosure provides a composition for gravure offset printing, including 7-92 parts by weight of a functional material, such as 75-92 parts by weight (in the case of a conductive composition), 15-40 parts by weight (in the case of an ITO etching paste), 10-30 parts by weight (in the case of an insulating colloid); 1-76 parts by weight of a polymer, such as 3-10 parts by weight (in the case of a conductive composition), 30-45 parts by weight (in the case of an ITO etching paste), 50-70 parts by weight (in the case of an insulating colloid); 4-13 parts by weight of a solvent, such as 4-5 parts by weight (in the case of a conductive composition), 5-13 parts by weight (in the case of an ITO etching paste), 6-13 parts by weight (in the case of an insulating colloid); 1-2.5 parts by weight of an additive, such as 1-1.5 parts by weight (in the case of a conductive composition), 1-2.5 parts by weight (in the case of an ITO etching paste), 1-2.5 parts by weight (in the case of an insulating colloid). The surface tension of the composition for gravure offset printing may be between about 20-40 mN/m, for example, 25-35 mN/m. It should be noted that, the functional material added in the composition for gravure offset printing may be altered depending on different functional requirements. For example, the functional materials may include conductive metal powder such as silver nanoparticles (AgNPs), insulating powders such as titanium dioxide (TiO₂) or silicon dioxide (SiO₂), and etching materials such as oxalic acid, phosphoric acid, or the like. To provide the composition for gravure offset printing with a surface tension between 20-40 mN/m, the surface energy of the polymer may be between 15-50 mN/m, such as 15-20 mN/m. The polymer may include polyvinylchloride (PVC), polymethyl methacrylate (PMMA), polyacrylate, polycarbonate (PC), or combinations thereof. Other polymers may be used to adjust the surface tension of the printing composition to the desirable range, as long as the polymer has a surface energy of between about 15-50 mN/m. To avoid a transfer failure resulting from rapid solvent evaporation during the gravure offset printing process, the boiling point of the solvent is preferably higher than 250° C. The solvent may include dipropylene glycol (DPG), triethylene glycol (TEG), tripropylene glycol methyl ether (TPGME), tetraethylene glycol dimethyl ether (TEGDME), or combinations thereof Other solvents mat be used to achieve the desired effects as long as the solvent has a boiling point higher than 250° C. Additives are used to adjust the final surface tension of the composition for gravure offset printing, which may include a dispersant, a surface tension adjusting agent, an antifoaming agent, or combinations thereof Specific examples of the additives may include aralkyl-based compounds such as BYK-special and BYK-323, polyether modified polydimethyl-based compounds such as BYK-special and BYK-323, or combinations thereof

During the process for manufacturing the composition for gravure offset printing, the composition may be thoroughly mixed by a blender at a speed of 400-1200 rpm for about 15-30 minutes, for example, and then fed to a three roller mill for about 1-5 times, for example, to uniformly disperse the components of the composition. It should be noted that the additives may be added before or after the mixing of the functional materials and the polymer with the solvent. For example, in one embodiment, the functional materials and the polymer are first uniformly stirred in the solvent and the additives are then added to adjust the surface tension of the mixture to between 20-40 mN/m. In another embodiment, the functional materials, the polymer, and the additives together are uniformly stirred and dispersed in the solvent to form a coating composition with a surface tension between 20-40 mN/m.

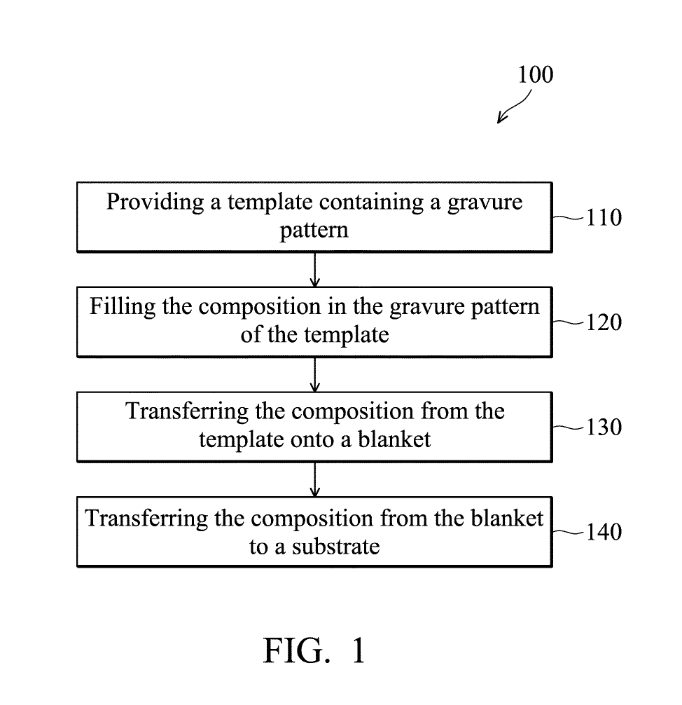

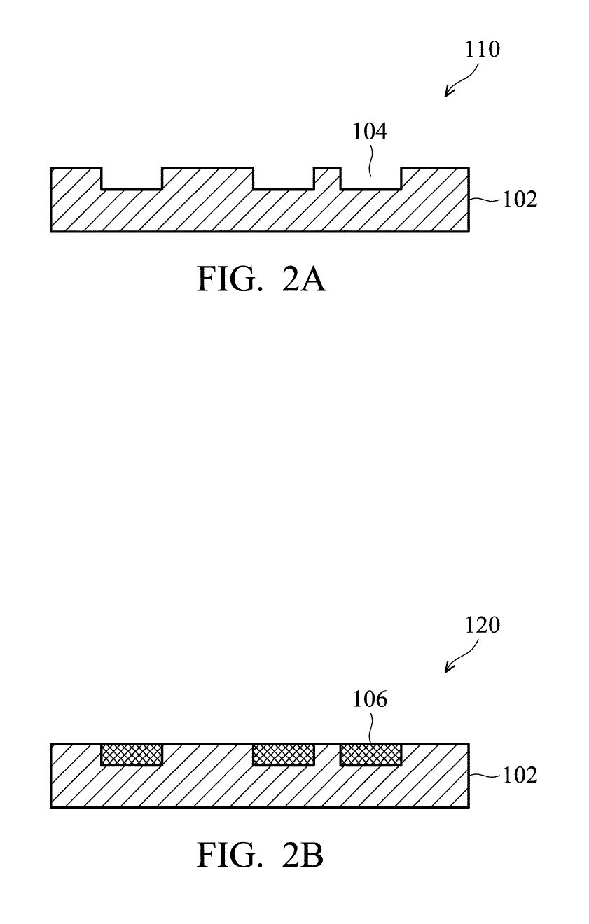

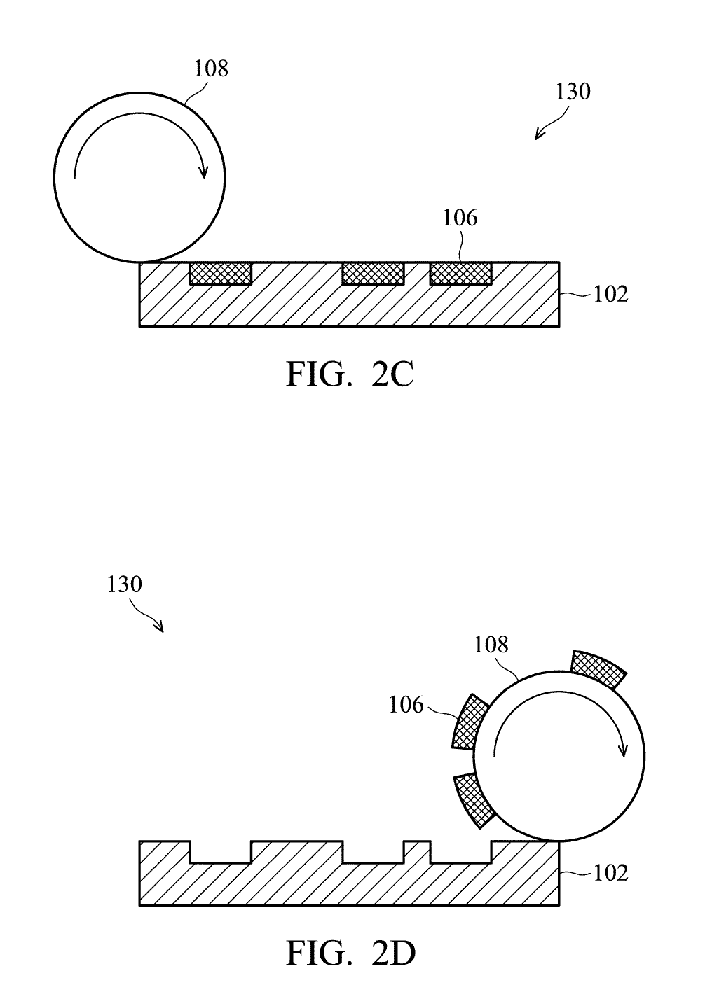

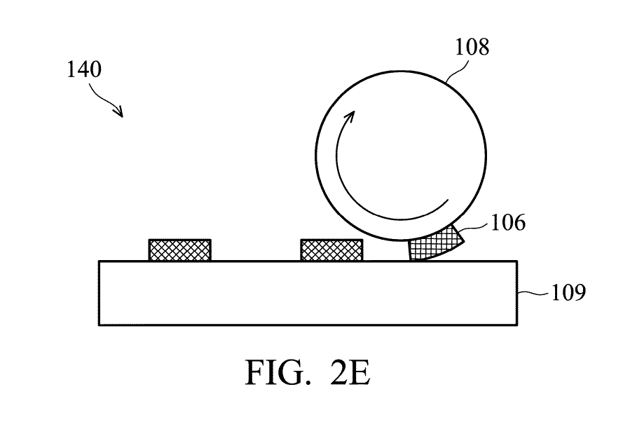

In another aspect, the disclosure provides a gravure offset printing process. FIG. 1 shows a flowchart 100 of the gravure offset printing process. The flowchart 100 begins at step 110 by providing a template 102 containing a gravure pattern 104, as shown in FIG. 2A. The gravure pattern 104 of the template 102 may have a line width of less than 50 μm, for example. The template 102 may include stainless steel, glass, ceramics, copper, or combinations thereof. Step 120 includes filling the composition 106 in the gravure pattern 104 of the template 102. The excess gravure offset printing composition 106 may be removed by a scraper to planarize the top surface of the template 102, as shown in FIG. 2B.

Referring to FIG. 2C, the flowchart 100 of the gravure offset printing process proceeds to step 130 by transferring the composition 106 from the template 102 onto a blanket 108. The blanket 108 may be drum-shaped, for example. The blanket 108 may be formed of a material including polydimethylsiloxane (PDMS), polyvinylchloride (PVC), polycarbonate (PC), or combinations thereof

Referring to FIG. 2D, the flowchart 100 of the gravure offset printing process proceeds to step 140 by transferring the composition 106 from the blanket 108 to a substrate 109. It should be noted that the substrate 109 of the disclosure is not limited to the planar substrate as shown in the figure. The substrate 109 may be a rigid substrate or a flexible substrate. The substrate 109 may include glass, polyethylene terephthalate (PET), or combinations thereof

The transfer ratio may be determined by the weight of the composition on the blanket and the weight of the composition transferred to the substrate by a microbalance. In some embodiments, the transfer ratio of the composition 106 from the blanket 108 to the substrate 109 is above 80%, for example, above 90%. The pattern transferred from the blanket 108 to the substrate 109 having a line width of less than 50 μm, for example, less than 20 μm.

The disclosure provides a composition for gravure offset printing with a high transfer ratio, which may be transferred onto the surface of the substrate by gravure offset printing, and shaped or activated by a thermal process to form a fine wire pattern on the substrate surface with a line width of less than 50 μm, and a transfer ratio above 80%. Distortion and disconnection of the wiring during the transferring process can be reduced. This composition with a high transfer ratio may be applied to the products with fine wires such as the touch panel, the metal network structure film, antennas of the radio frequency recognition system, printed circuit boards, or thin-film transistor (TFT).

The composition for gravure offset printing and the characteristics thereof are described in Examples and Comparative Examples listed below:

### Examples 1

[Conductive Composition with a High Transfer Ratio]

0.2 g of nano silver dispersant was added into 0.5 g of tetraethylene glycol dimethyl ether (TEGDME) and stirred by a blender at a speed of 250 rpm for 10 minutes such that the dispersant was uniformly dispersed in the solvent (WD-602 from Gimpli). Then, 10 g of silver nanoparticles (AgNPs) was added and dispersed by a blender. 0.3 g of acrylic resin with a low surface energy (phenolic polymer form Chembridge) was added to the above mixture and uniformly dispersed by a three roller mill for three times. At last, after 0.05 g of an antifoaming agent (BYK-special) and 0.1 g of a surface tension adjusting agent (BYK-323) were added, a conductive composition with a high transfer ratio was prepared.

To test the effect of the surface tension of composition on the transfer ratio, a gravure offset printing test was conducted after 0.1 g of the surface tension adjusting agent (BYK-323) was added into the conductive composition. The experimental results show that when 0.1 g of the surface tension adjusting agent (BYK-323) was added to the conductive composition, the measured surface tension was about 32.7 mN/m, and the conductive composition could be removed from the template by a blanket and fully transferred to the substrate surface. The conductive composition on the blanket and the conductive composition transferred to the substrate were weighted by a microbalance, giving a transfer ratio of above 97%. The line width of the substrate pattern was about 40.1 μm.

### Comparative Examples 1

### [Conductive Composition]

To evaluate the effect of surface tension of the gravure offset printing composition on the transfer ratio, the same procedure as described in Example 1 was repeated, except that the surface tension adjusting agent was increased to 3 g. The experimental results of the gravure offset printing test show that when 3 g of the surface tension adjusting agent (BYK-323) was added to the conductive composition, the measured surface tension was about 17 mN/m, similar to that of the blanket, and therefore most of the conductive composition adhered to the blanket and could not be transferred completely. The transfer ratio was reduced to about 63%, along with a decreased thickness of the transferred film.

### Examples 2

[Indium Tin Oxide (ITO) Etching Paste with a High Transfer Ratio]

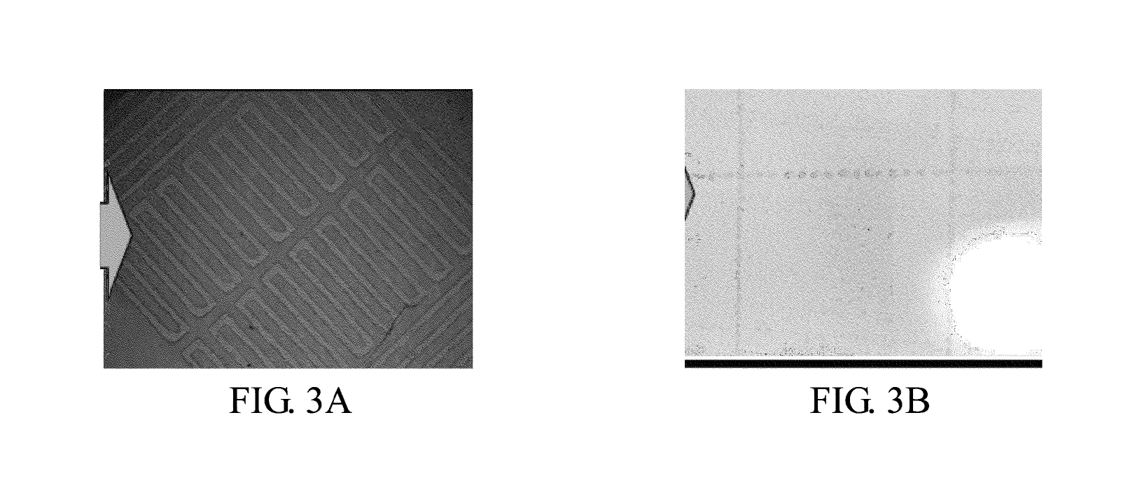

3 g of acrylic material (phenolic polymer from Chembridge) with a low surface energy was added into 0.5 g of tetraethylene glycol dimethyl ether (TEGDME) and stirred by a blender at a speed of 250 rpm for 10 minutes such that the acrylic material was uniformly dispersed in the solvent (WD-602 from Gimpli). Then, 1 g of oxalic acid, phosphoric acid, and ferric chloride were added and uniformly dispersed by a three roller mill for three times. At last, after 0.05 g of an antifoaming agent (BYK-special) and 0.8 g of a surface tension adjusting agent (BYK-323) were added, an etching composition with a high transfer ratio was prepared. The measured surface tension was about 35 mN/m. The experimental results of the gravure offset printing test show that the etching composition could be fully transferred to the substrate surface. The etching composition on the blanket and the etching composition transferred to the substrate were weighted by a microbalance, giving a transfer ratio of above 98%. After a heating process, the etching composition removed indium tin oxide (ITO) from an indium tin oxide (ITO) glass. FIG. 3A shows the transferring results of the etching composition according to the gravure offset printing test. In FIG. 3A, the line width of the substrate pattern was about 40 μm.

### Comparative Examples 2

### [Indium Tin Oxide (ITO) Etching Paste]

To evaluate the effect of surface tension of the composition for gravure offset printing on the transfer ratio, the same procedure as described in Example 2 was repeated, except that the surface tension adjusting agent was not added into the indium tin oxide (ITO) etching composition, and the measured surface tension was about 54 mN/m. This etching composition formed droplets on the surface of the blanket during the transferring process, and thus resulted in pattern distortion when it was transferred to the surface of the indium tin oxide (ITO) glass, as shown in FIG. 3B. The transfer ratio was only about 57%.

### Examples 3

[Insulating Colloid with a High Transfer Ratio]

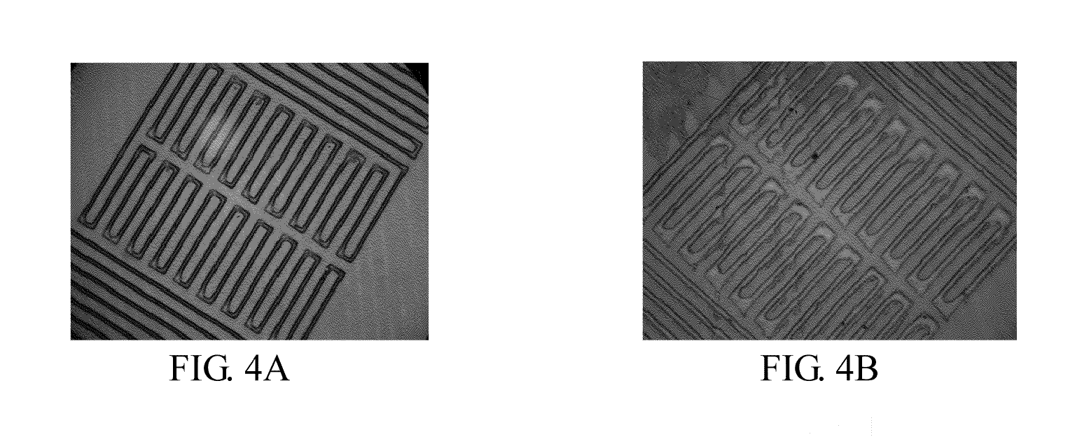

3 g of acrylic material (phenolic polymer from Chembridge) with a low surface energy was added into 0.5 g of tetraethylene glycol dimethyl ether (TEGDME) and stirred by a blender at a speed of 250 rpm for 10 minutes such that the acrylic material was uniformly dispersed in the solvent (WD-602 from Gimpli). Then, 0.3 g of titanium dioxide (TiO₂) was added and uniformly dispersed by a three roller mill for three times. At last, after 0.05 g of an antifoaming agent (BYK-special) and 0.1 g of a surface tension adjusting agent (BYK-323) were added, an insulating composition with a high transfer ratio was prepared. The measured surface tension was about 28.8 mN/m. The experimental results of the gravure offset printing test show that the insulating composition was fully transferred to the substrate surface. The insulating composition on the blanket and the insulating composition transferred to the substrate were weighted by a microbalance, giving a transfer ratio of above 96%. FIG. 4A shows the transferring results of the insulating composition with different surface tensions according to the gravure offset printing test. In FIG. 4A, the line width of the substrate pattern was about 20 μm.

### Comparative Examples 3

### [Insulating Colloid]

To evaluate the effect of surface tension of the composition for gravure offset printing on the transfer ratio, the same procedure as described in Example 3 was repeated, except that the polymer was replaced with poly vinyl pyrrolidone (PVP), and the measured surface tension was increased to 42.4 mN/m. The results of the gravure offset printing test show that a part of the insulating composition adhered to the surface of the blanket, and resulted in a gradual distortion of pattern, as shown in FIG. 4B. The transfer ratio was only about 71%.

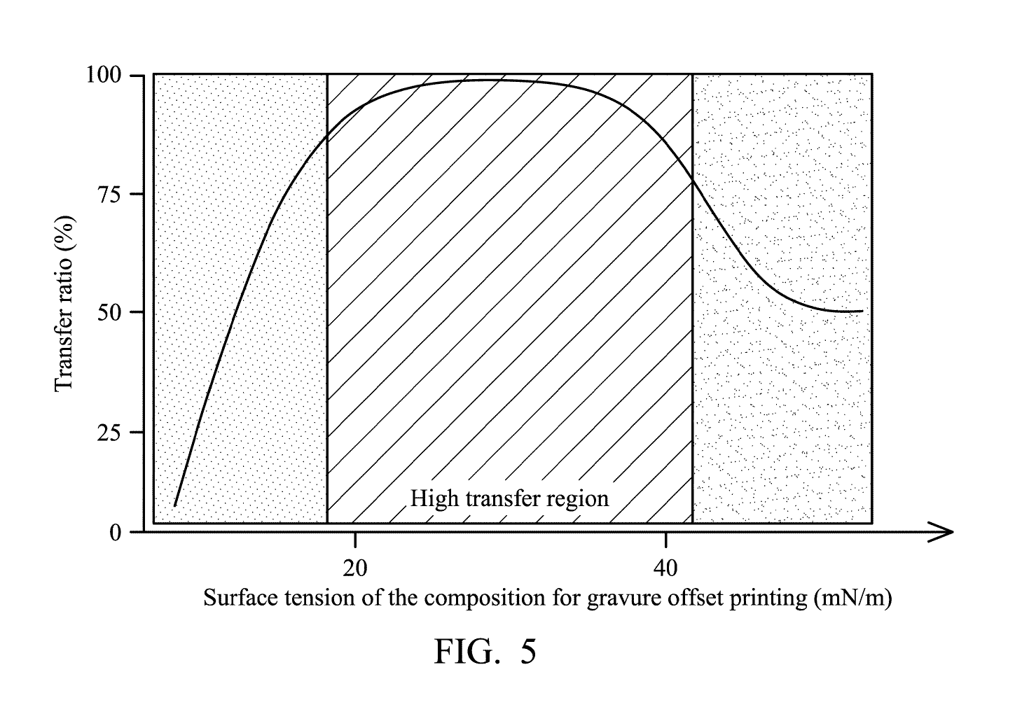

FIG. 5 shows the range of surface tension of the composition for gravure offset printing according to some embodiments of the disclosure. Nowadays, most of blankets used for gravure offset printing are polydimethylsiloxane (PDMS) or soft rubber, which are characterized by a low surface energy. Therefore, in the design of composition for gravure offset printing, if the surface energy of a composition is less than about 20 mN/m, the composition will adhere to the surface of the blanket due to a similar property with that of the blanket. In contrast, if the surface tension of the composition is more than about 40 mN/m, the composition will form droplets on the surface of the blanket and result in distortion of the transferred pattern.

The ingredients and characteristics of the compositions of each Example and Comparative Example are shown in Table 1:

TABLE 1

| | | | | | Surface | Transfer |
|---|---|---|---|---|---|---|
| | Functional | | | | tension | ratio |
| | material | Polymer | Solvent | Additive | (mN/m) | (%) |
| Conductive | Silver nano- | Phenol based | TEGDME | Surface tension | 32.7 | 97 |
| composition | particles (AgNPs) | polymer | (0.5 g) | adjusting agent | | |
| | (10 g) | (0.3 g) | | (0.1 g) | | |
| | Silver nano- | Phenol based | TEGDME | Surface tension | 17.0 | 63 |
| | particles (AgNPs) | polymer | (0.5 g) | adjusting agent | | |
| | (10 g) | (0.3 g) | | (3 g) | | |
| Etching | Oxalic acid, | Phenol based | TEGDME | Surface tension | 35.0 | ~98 |
| composition | phosphoric acid, | polymer | (0.5 g) | adjusting agent | | |
| | and ferric chloride | (3 g) | | (0.8 g) | | |
| | (1 g) | | | | | |
| | Oxalic acid, | Phenol based | TEGDME | Surface tension | 54.0 | 57 |
| | phosphoric acid, | polymer | (0.5 g) | adjusting agent | | |
| | and ferric chloride | (3 g) | | (0 g) | | |
| | (1 g) | | | | | |
| Insulating | TiO₂ | Phenol based | TEGDME | Surface tension | 28.8 | 96 |
| composition | (0.3 g) | polymer | (0.5 g) | adjusting agent | | |
| | | (3 g) | | (0.1 g) | | |
| | TiO₂ | PVP | TEGDME | Surface tension | 42.4 | 71 |
| | (0.3 g) | (3 g) | (0.5 g) | adjusting agent | | |
| | | | | (0.1 g) | | |

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A composition for gravure offset printing, comprising:
7-92 parts by weight of a functional material;
1-76 parts by weight of a polymer;
4-13 parts by weight of a solvent; and
1-2.5 parts by weight of an additive,
wherein a surface tension of the composition is between 20-40 mN/m.

2. The composition for gravure offset printing as claimed in claim 1, wherein the functional material comprises a conductive powder, an insulating powder, or an etching paste.

3. The composition for gravure offset printing as claimed in claim 1, wherein a surface energy of the polymer is between 15 and 50 mN/m.

4. The composition for gravure offset printing as claimed in claim 1, wherein the polymer comprises polyvinylchloride (PVC), polymethyl methacrylate (PMMA), polyacrylate, polycarbonate (PC), or combinations thereof.

5. The composition for gravure offset printing as claimed in claim 1, wherein the solvent has a boiling point above 250° C.

6. The composition for gravure offset printing as claimed in claim 1, wherein the solvent comprises dipropylene glycol (DPG), triethylene glycol (TEG), tripropylene glycol methyl ether (TPGME), tetraethylene glycol dimethyl ether (TEGDME), or combinations thereof.

7. The composition for gravure offset printing as claimed in claim 1, wherein the additive comprises a dispersant, a surface tension adjusting agent, an antifoaming agent, or combinations thereof.

8. The composition for gravure offset printing as claimed in claim 7, wherein the additive comprises aralkyl-based compound, polyether modified polydimethyl-based compound, or combinations thereof.

9. A gravure offset. printing process, comprising:
providing a template containing a gravure pattern;
filling the composition as defined in claim I in the gravure pattern of the template;
transferring the composition from the template onto a blanket; and
transferring the composition from the blanket to a substrate, wherein a transfer ratio of the composition from the blanket to the substrate is more than 80%.

10. The gravure offset printing process as claimed in claim 9, wherein the template comprises stainless steel, glass, ceramics, copper, or combinations thereof.

11. The gravure offset printing process as claimed in claim 9, wherein the blanket comprises polydimethylsiloxane (PDMS), polyvinylchloride (PVC), polycarbonate (PC), or combinations thereof.

12. The gravure offset printing process as claimed in claim 9, wherein the substrate comprises glass, polyethylene terephthalate (PET), or combinations thereof.

13. The gravure offset printing process as claimed in claim 9, wherein a pattern transferred from the blanket to the substrate having a line width less than 50 μm.
